(19) United States
(12) Patent Application Publication
(10) Pub. No.: US 2026/0052589 A1
(43) Pub. Date: Feb. 19, 2026

(54) SYSTEMS AND METHODS FOR WIRELESS LOCAL AREA NETWORK AND CELLULAR WIRELESS CORE NETWORK INTERWORKING

(71) Applicant: Verizon Patent and Licensing Inc., Basking Ridge, NJ (US)

(72) Inventor: Eric R. Sporel, Westford, MA (US)

(21) Appl. No.: 18/808,724

(22) Filed: Aug. 19, 2024

(51) Int. Cl. H04W 76/12; H04W 60/00; H04W 88/18

(52) U.S. Cl. CPC H04W 76/12; H04W 60/00; H04W 88/182

(57) ABSTRACT

A device may include a processor configured to receive an access request to access a core network from a Wireless Local Area Network (WLAN) access device. The processor may be further configured to register with the core network as a User Equipment (UE) device using a UE device identifier associated with the WLAN access device, based on receiving the request to access the core network from the WLAN access device; establish a Protocol Data Unit (PDU) session with the core network as a UE device using the UE device identifier associated with the WLAN access device; and proxy data traffic between the WLAN access device and core network using the established PDU session.

### BACKGROUND INFORMATION

To satisfy the needs and demands of users of mobile communication devices, providers of wireless communication services continue to improve and expand available services as well as networks used to deliver such services. One aspect of such improvements includes enabling mobile communication devices to access and use various services via the provider’s communication network across different types of devices or access points. Managing a wireless communication service over time across different devices or access points may pose various difficulties.

### BRIEF DESCRIPTION OF THE DRAWINGS

FIG. 1 illustrates an environment according to an implementation described herein;

FIG. 2 illustrates exemplary components of a Fifth Generation (5G) core network according to an implementation described herein;

FIG. 3 illustrates exemplary components of a device that may be included in an environment according to an implementation described herein;

FIG. 4 illustrates exemplary components of a user equipment (UE) and Radio Access Network (RAN) proxy according to an implementation described herein;

FIG. 5 illustrates exemplary components of a Wireless Local Area Network (WLAN) access device database (DB) according to an implementation described herein;

FIG. 6 illustrates a flowchart of a process for interworking WLAN and cellular wireless core network according to an implementation described herein;

FIG. 7 illustrates a first exemplary signal flow diagram according to an implementation described herein; and

FIG. 8 illustrates a second exemplary signal flow diagram according to an implementation described herein.

### DETAILED DESCRIPTION OF PREFERRED EMBODIMENTS

The following detailed description refers to the accompanying drawings. The same reference numbers in different drawings identify the same or similar elements.

Providers of wireless communication services operate radio access networks (RANs) that include base stations. The base stations enable cellular wireless communication devices (e.g., smart phones, etc.), referred to as user equipment (UE) devices (also herein referred to as UEs), to connect to networks and obtain services via the provider’s core network, such as a Fourth Generation (4G) core network, a Fifth Generation (5G) core network, and/or other next generation networks as defined by the 3^{rd} Generation Partnership Project (3GPP). 5G coverage may be provided using 5G base stations, referred to as gNodeBs, implementing the 5G New Radio (NR) air interface. In order to establish a communication session, a UE device may establish a Protocol Data Unit (PDU) session in the core network, via the RAN. The PDU session may enable the UE device to communicate with another network via the RAN and core networks. The UE device may then establish one or more data flows in the PDU session. Each data flow may be associated with a Quality of Service (QoS) and/or other types of service requirements and may also be referred to as a “QoS data flow” or a “QoS flow.”

A provider may also function as an Internet Service Provider (ISP) for customer networks. For example, a customer may purchase a subscription that includes use of a wireless local area network (WLAN) access device for a customer premises equipment (CPE) network. The CPE network may include a Layer 2 and/or Layer 3 WLAN that enables devices to communicate with each other and/or connect to the Internet or other networks using the WLAN access device. The WLAN access device may correspond to a Wireless Fidelity (WI-FI) router and access point (AP) that provides short-range wireless access for devices in the CPE network. Such a device may be referred to as a “WI-FI router.” Client devices in the customer’s CPE network, such as a laptop computer, a tablet computer device, a mobile phone, and/or a gaming console may connect to the Internet via the WI-FI router. WI-FI routers operate in WLANs based on the Institute of Electrical and Electronics Engineers (IEEE) 802.11 standards. Such WLANs are referred to as WI-FI networks.

The provider may seek to integrate cellular wireless communication services with ISP services for CPE networks. For example, the provider may enable WLAN access devices, such as WI-FI routers, to connect to the cellular wireless core network (referred to herein as “core network”) as non-3GPP devices. A 5G core network may include a Non-3GPP Inter-Working Function (N3IWF). The N3IWF may interconnect a non-3GPP device, such as the WI-FI router, with the core network. However, deployment of an N3IWF in a 5G core network may require use of network resources and technicians as well as the modification of various components in a 5G core network. For example, the use of an N3IWF in a 5G core network may require implementation of various network function (NF) interfaces and deployment of associated microservices and process flows in order to enable the functioning of the N3IWF in the 5G core network. Thus, the deployment of a N3IWF in a 5G core network may be undesirable.

Implementations described herein relate to systems and methods for WLAN and cellular wireless core network interworking without requiring modification of a cellular wireless core network. The interworking between the WLAN and the cellular wireless core network may be performed by a UE and RAN proxy that causes the core network to communicate with the WLAN access device as if the WLAN access device corresponded to a UE device connecting to the core network via a RAN. A “proxy,” as the term is used herein, refers to a device that acts as an intermediary between a first device communicating with a second device, or refers to a process of receiving messages from the first device and forwarding the messages to the second device and receiving messages from the second device and forwarding the messages to the first device. A RAN proxy may function as a gNodeB proxy as well as a proxy for other components of a RAN that may be configured to implement a policy and/or service requirement for a communication session, such as, for example, a transport network component (e.g., a programmable switch) in a RAN.

A device configured to function as the UE and RAN proxy may be configured to receive an access request to access a core network from a WLAN access device; register with the core network as a UE device using a UE device identifier associated with the WLAN access device, based on receiving the request; establish a PDU session with the core network as a UE device using the UE device identifier associated with the WLAN access device; and proxy data traffic between the WLAN access device and core network using the established PDU session.

Registering with the core network as a UE device may include sending a registration request, using the UE device identifier associated with the WLAN access device, to an Access and Mobility Management Function (AMF) associated with the core network using an N2 interface and receiving a registration acceptance from the AMF based on the sent registration request.

Proxying data traffic between the WLAN access device and core network using the established PDU session may include identifying a User Plane Function (UPF) associated with the PDU session, sending uplink data traffic for the PDU session from the WLAN access device to the identified UPF using an N3 interface, and receiving downlink data traffic for the PDU session from the identified UPF using the N3 interface.

Proxying data traffic between the WLAN access device and core network using the established PDU session may further include sending downlink data traffic for the PDU session to the WLAN access device using a data link layer Point-to-Point (PPP) protocol, such as, for example, Point-to-Point Protocol over Ethernet (PPPoE) and/or receiving uplink data traffic for the PDU session from the WLAN access device using PPPoE.

Proxying data traffic between the WLAN access device and core network using the established PDU session may further include processing the data traffic as a gNodeB proxy. Processing the data traffic as the gNodeB proxy may include receiving an indication that the PDU session has been assigned to a network slice and processing data traffic associated with the PDU session based on one or more requirements associated with the network slice.

Processing the data traffic as the gNodeB proxy may further include determining a Fifth Generation Quality of Service Identifier (5QI) associated with a data flow in the established PDU session and processing data units associated with the data flow based on the determined 5QI. Processing the data traffic as the gNodeB proxy may further include reporting at least one Key Performance Indicator (KPI) value to a Network Data Analytics Function (NWDAF) associated with the core network.

Processing the data traffic as the gNodeB proxy may include establishing, for the PDU session, a General Packet Radio Service Tunnelling Protocol (GTP) tunnel between the device and a UPF associated with the PDU session and establishing, for the PDU session, an Internet Protocol Security (IPSec) tunnel between the device and the WLAN access device.

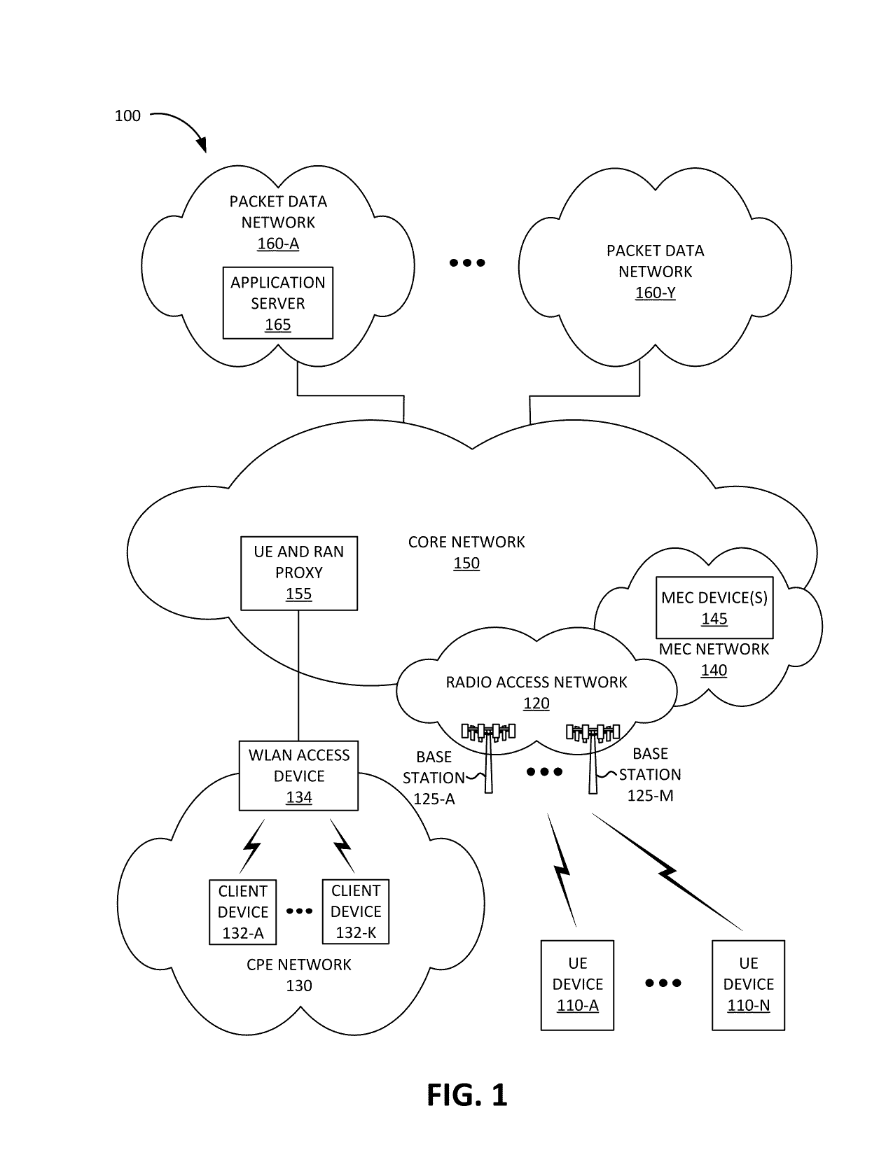

FIG. 1 is a diagram of an exemplary environment 100 in which the systems and/or methods described herein may be implemented. As shown in FIG. 1, environment 100 may include UE devices 110-A to 110-N (referred to herein collectively as “UE devices 110” and individually as “UE device 110”), a RAN 120 that includes base stations 125-A to 125-M (referred to herein collectively as “base stations 125” and individually as “base station 125”), a CPE network 130, a Multi-Access Edge Computing (MEC) network 140, a core network 150, and packet data networks (PDNs) 160-A to 160-Y (referred to herein collectively as “PDNs 160” and individually as “PDN 160”).

UE device 110 may include any mobile device with cellular wireless communication functionality. UE device 110 may include a handheld wireless communication device (e.g., a mobile phone, a smart phone, a tablet device, etc.); a wearable computer device (e.g., a head-mounted display computer device, a wristwatch computer device, etc.); a laptop computer, a tablet computer, a portable gaming system, and/or another type of portable computer; a Fixed Wireless Access (FWA) device; and/or any other type of mobile computer device with cellular wireless communication capabilities. In some implementations, UE device 110 may communicate using machine-to-machine (M2M) communication, such as Machine Type Communication (MTC), and/or another type of M2M communication for IoT applications.

RAN 120 may include base stations 125 and be managed by a provider of wireless communication services. RAN 120 may enable UE devices 110 to connect to core network 150 via base stations 125 using cellular wireless signals. For example, RAN 120 may include one or more central units (CUs), distributed units (DUs), and/or Radio Units (RUs) (not shown in FIG. 1) that enable and manage connections from RUs to core network 150. Furthermore, RAN 120 may include programmable switches, or other types of transport network elements, between an RU and a DU, and/or between a DU and a CU, which may be programmed to implement policies and/or service requirements for data sessions managed by RAN 120 between UE device 110 and core network 150. RAN 120 may include features associated with an Long-Term Evolution (LTE) Advanced (LTE-A) network and/or a 5G network or other advanced network, such as features for or associated with management of 5G NR base stations; carrier aggregation; advanced or massive Multiple-Input Multiple Output (MIMO) configurations (e.g., an 8x8 antenna configuration, a 16x16 antenna configuration, a 256x256 antenna configuration, etc.); cooperative MIMO (CO-MIMO); relay stations; Heterogeneous Networks (HetNets) of overlapping small cells and macrocells; Self-Organizing Network (SON) functionality; MTC functionality, such as 1.4 Megahertz (MHz) wide enhanced MTC (eMTC) channels (also referred to as category Cat-M1), Low Power Wide Area (LPWA) technology such as Narrow Band (NB) IoT (NB-IoT) technology, and/or other types of MTC technology; and/or other types of LTE-A and/or 5G functionality.

Base station 125 may include a 5G NR base station (e.g., a gNodeB) and/or a 4G LTE base station (e.g., an eNodeB). Base stations 125 may include devices and/or components configured to enable cellular wireless communication with UE devices 110. For example, base stations 125 may include a radio frequency (RF) transceiver configured to communicate with UE devices 110 using a 5G NR air interface using a 5G NR protocol stack, a 4G LTE air interface using a 4G LTE protocol stack, and/or using another type of cellular air interface.

CPE network 130 may be associated with a customer of a provider managing core network 150 and/or RAN 120. For example, CPE network 130 may include a WLAN in a residence, place of business, government office, etc. CPE network 130 may include WLAN access device 134 and client devices 132-A to 132-K (referred to herein collectively as “client devices 132” and individually as “client device 132”). Client device 132 may include any device with WI-FI wireless communication functionality, such as any type of device described above with reference to UE devices 110.

WLAN access device 134 may include a device that functions as an access gateway between CPE network 130 and core network 150. The access gateway may function as a Fixed Network Residential Gateway (FN-RG) device that connects to core network 150 via a wired connection and/or provides an Internet connection to CPE network 130. Furthermore, WLAN access device 134 may include a transceiver configured to communicate with client devices 132 using WI-FI signals based on the IEEE 802.11 standards for implementing a wireless LAN (WLAN) network. WLAN access device 134 may function as a wireless router that enables client devices 132 to communicate with other client devices 132 via WI-FI signals. Furthermore, WLAN access device 134 may function as a WI-FI Access Point (AP) that enables client devices 132 to connect to PDNs 160 via core network 150. WLAN access device 134 may connect to core network 150 via UE and RAN proxy 155. WLAN access device 134 may connect to UE and RAN proxy 155 via an Internet Protocol (IP) connection over a wired connection (e.g., Ethernet connection, optical network connection, etc.). In some implementations, WLAN access device 134 may include the WI-FI AP. In other implementations, WLAN access device 134 may be separate from a WI-FI AP and may function as a CPE router connected to a WI-FI AP, or connected to multiple WI-FI APs, in CPE network 130.

MEC network 140 may be associated with RAN 120 and may provide MEC services for UE devices 110 attached to base stations 125. MEC network 140 may be in proximity to base stations 125 from a geographic and network topology perspective, thus enabling low latency services to be provided to UE devices 110. As an example, MEC network 140 may be located on the same site as base station 125. As another example, MEC network 140 may be geographically closer to one of base stations 125 and reachable via fewer network hops and/or fewer switches, than other macro cell base stations 125.

MEC network 140 may include one or more MEC devices 145. MEC devices 145 may provide MEC services to UE devices 110. A MEC service may include, for example, a low-latency microservice associated with a particular application, a microservice associated with a virtualized network function (VNF) of core network 150, a cloud computing service, such as cache storage service, artificial intelligence (AI) accelerator service, machine learning service, an image processing service, a data compression service, a locally centralized gaming service, a Graphics Processing Units (GPUs) and/or other types of hardware accelerator service, and/or other types of cloud computing services.

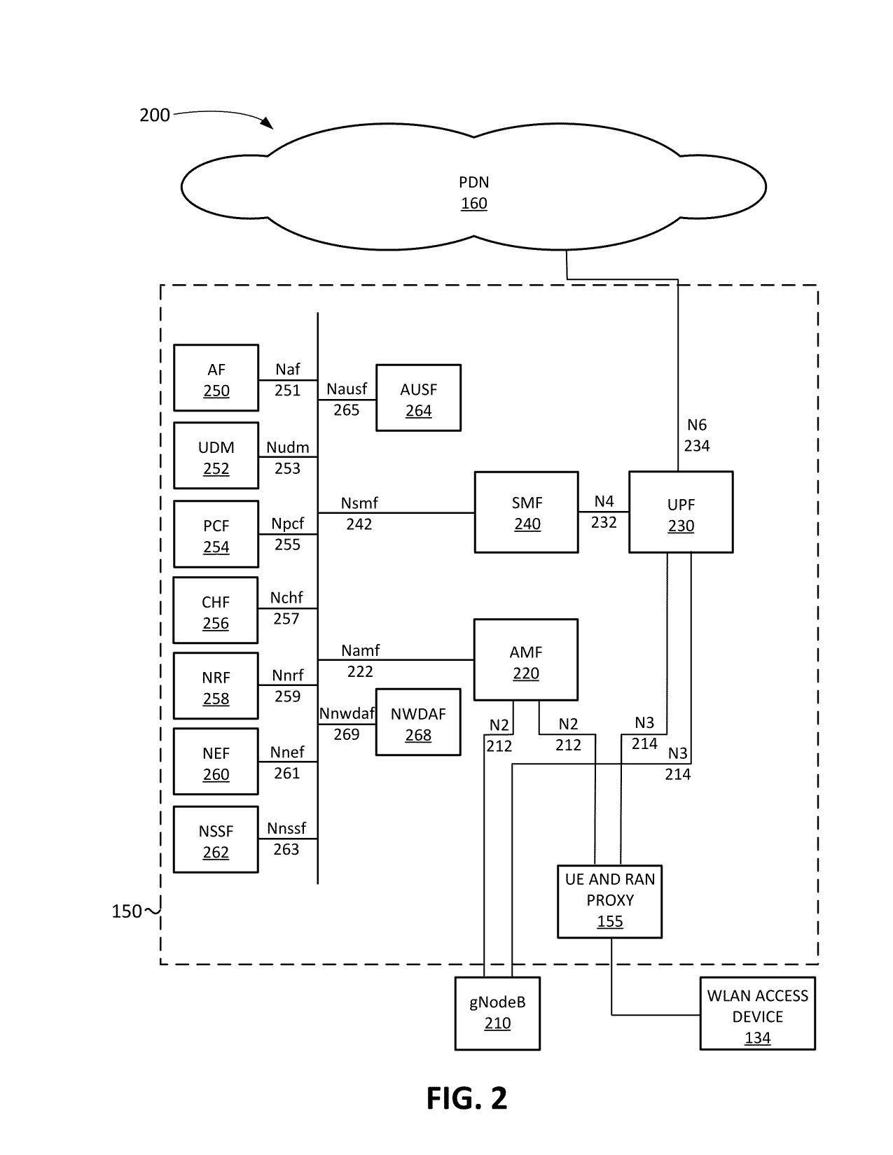

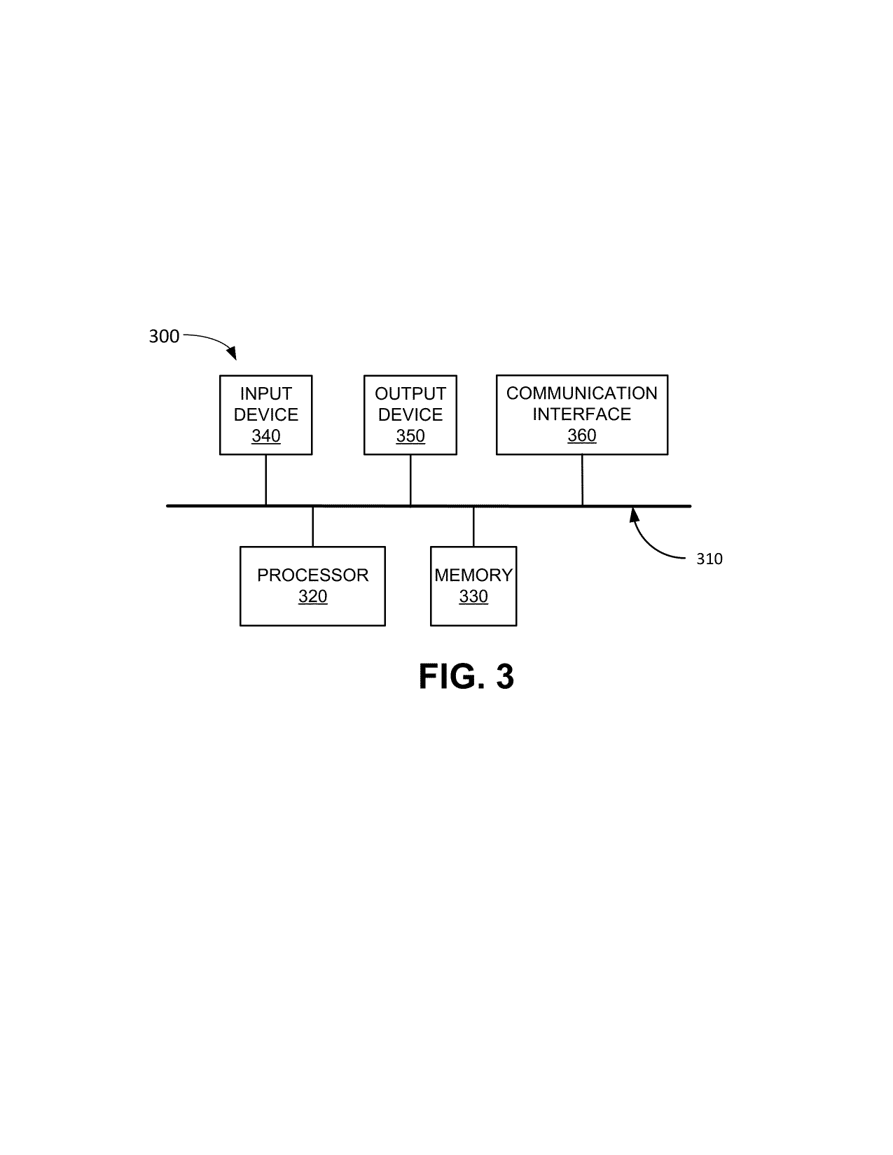

Core network 150 may be managed by the provider of cellular wireless communication services and may manage communication sessions of subscribers connecting to core network 150 via RAN 120 and/or CPE network 130. For example, core network 150 may establish an IP connection between UE devices 110, and/or WLAN access device 134, and PDN 160. The components of core network 150 may be implemented as dedicated hardware components and/or as Virtual Network Functions (VNFs) implemented on top of a common shared physical infrastructure using Software Defined Networking (SDN). For example, an SDN controller may implement one or more of the components of core network 150 using an adapter implementing a VNF virtual machine, a Cloud-Native Network Function (CNF) container, an event driven serverless architecture, and/or another type of SDN architecture. The common shared physical infrastructure may be implemented using one or more devices 300 described below with reference to FIG. 3 in a cloud computing center associated with core network 150. Additionally, or alternatively, at least some of the components of core network 150 may be implemented using MEC devices 145 in MEC network 140. Core network 150 may include UE and RAN proxy 155. Other exemplary components that may be included in core network 150 are described below with reference to FIG. 2.

UE and RAN proxy 155 may function as a UE and/or RAN proxy on behalf of WLAN access device 134 so that core network 155 perceives WLAN access device 134 as UE device 110 establishing a connection to core network 150 via base station 125 and RAN 120. For example, UE and RAN proxy 155 may establish a PDU session to a UPF device in core network 150 and from the perspective of core network 150, the PDU session may be perceived as originating from UE device 110 via base station 125.

PDNs 160-A to 160-Y may each be associated with a Data Network Name (DNN) in 5G, and/or an Access Point Name (APN) in 4G. UE device 110 may request a connection to PDN 160 using a DNN or an APN. For example, UE device 110 may request a data flow connection to an application server 165 (shown in PDN 160-A). PDN 160 may include, and/or be connected to, a local area network (LAN), a wide area network (WAN), a metropolitan area network (MAN), an autonomous system (AS) on the Internet, an optical network, a cable television network, a satellite network, a wireless network, an ad hoc network, a telephone network (e.g., the Public Switched Telephone Network (PSTN) or a cellular network), an intranet, or a combination of networks. PDN 160 may include application server 165. Application server 165 may include one or more computer devices that host one or more applications and/or other types of services used by UE device 110 and/or client devices 132. Core network 150 may establish a communication session between UE device 110 and application server 165 via RAN 120 or a communication session between client device 132 and application server 165 via WLAN access device 134.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

FIG. 2 is a diagram illustrating exemplary components of an environment 200 that includes WLAN access device 134, gNodeB 210, core network 150, and PDN 160. In environment 200, core network 150 includes a 5G core network. gNodeB 210 may be implemented by base station 125. Core network 150 may include UE and RAN proxy 155, an AMF 220, a UPF 230, a Session Management Function (SMF) 240, Application Function (250), a Unified Data Management (UDM) 252, a Policy Charging Function (PCF) 254, a Charging Function (CHF) 256, a Network Repository Function (NRF) 258, a Network Exposure Function (NEF) 260, a Network Slice Selection Function (NSSF) 262, an Authentication Server Function (AUSF) 264, and a NWDAF 268. While FIG. 2 depicts a single AMF 220, UPF 230, SMF 240, AF 250, UDM 252, PCF 254, CHF 256, NRF 258, NEF 260, NSSF 262, AUSF 264, NWDAF 268, and N3IWF 274 for illustration purposes, in practice, core network 150 may include multiple AMFs 220, UPFs 230, SMFs 240, AFs 250, UDMs 252, PCFs 254, CHFs 256, NRFs 258, NEFs 260, NSSFs 262, AUSF 264, and/or NWDAFs 268.

AMF 220 may perform registration management, connection management, reachability management, mobility management, lawful intercepts, session management messages transport between UE device 110, and/or UE and RAN proxy 155, and SMF 240, access authentication and authorization, location services management, support non-3GPP access networks, and/or other types of management processes. AMF 220 may be accessible by other function nodes via an Namf interface 222. AMF 220 may communicate with gNodeB 210, and/or UE and RAN proxy 155, via an N2 interface 212.

UPF 230 may maintain an anchor point for intra/inter-Radio Access Technology (RAT) mobility, maintain an external PDU point of interconnect to a particular PDN 160, perform packet routing and forwarding, perform the user plane part of policy rule enforcement, perform packet inspection, perform lawful intercept, perform traffic usage reporting, perform QoS handling in the user plane, perform uplink traffic verification, perform transport level packet marking, perform downlink packet buffering, forward an “end marker” to a RAN node (e.g., gNodeB 210), and/or perform other types of user plane processes. UPF 230 may communicate with gNodeB 210, and/or UE and RAN proxy 155, using an N3 interface 214, communicate with SMF 240 using an N4 interface 232, and connect to PDN 160 using an N6 interface 234.

SMF 240 may perform session establishment, session modification, and/or session release, apply policies received from PCF 254 to data flows, perform IP address allocation and management, perform Dynamic Host Configuration Protocol (DHCP) functions, perform selection and control of UPF 230, configure traffic steering at UPF 230 to guide the traffic to the correct destinations, perform lawful intercepts, charge data collection, support charging interfaces, control and coordinate charging data collection, terminate session management parts of Non-Access Stratum messages, perform downlink data notification, manage roaming functionality, and/or perform other types of control plane processes for managing user plane data. SMF 240 may be accessible via an Nsmf interface 242.

AF 250 may provide services associated with a particular application, such as, for example, an application associated with application server 165, an application for accessing NEF 260, an application for interacting with a policy framework for policy control, and/or other types of applications. AF 250 may be accessible via an Naf interface 251, also referred to as an NG5 interface. In some implementations, AF 250 may correspond to, or interface with application server 180.

UDM 252 may maintain subscription information for UE devices 110 in a Unified Data Repository (UDR), manage subscriptions, generate authentication credentials, handle user identification, perform access authorization based on subscription data, perform network function registration management, maintain service and/or session continuity by maintaining assignment of SMF 240 for ongoing sessions, support SMS delivery, support lawful intercept functionality, and/or perform other processes associated with managing user data. UDM 252 may store information for a UE subscription associated with WLAN access device 134. UDM 252 may be accessible via a Nudm interface 253.

PCF 254 may support policies to control network behavior, provide policy rules to control plane functions (e.g., to SMF 240), access subscription information relevant to policy decisions, perform policy decisions, and/or perform other types of processes associated with policy enforcement. PCF 254 may assign a QoS class to a data flow associated with a PDU session and provide a QoS class ID (QCI), such as a 5G QCI (5QI), to UPF 230 associated with the data flow and/or to transport network elements in RAN 130 (e.g., a Central Unit Control Plane (CU-CP), etc.). PCF 254 may provide one or more RAN policies, for a PDU session and/or data flow associated with WLAN access device 134, to UE and RAN proxy 155 to implement on the PDU session and/or data flow. PCF 254 may be accessible via Npcf interface 255. CHF 256 may perform charging and/or billing functions for core network 150. CHF 256 may be accessible via Nchf interface 257.

NRF 258 may support a service discovery function and maintain profiles of available NF instances and their supported services. NRF 258 may be accessible via an Nnrf interface 259. NEF 260 may expose capabilities and events to other NFs, including third party NFs, AFs, edge computing NFs, and/or other types of NFs. Furthermore, NEF 260 may secure provisioning of information from external applications to core network 150, translate information between core network 150 and devices/networks external to core network 150, support a Packet Flow Description (PFD) function, and/or perform other types of network exposure functions. NEF 260 may be accessible via Nnef interface 261.

NSSF 262 may select a set of network slice instances to serve a particular UE device 110, determine network slice selection assistance information (NSSAI) or a Single-NSSAI (S-NSSAI), determine a particular AMF 220 to serve a particular UE device 110, and/or perform other types of processing associated with network slice selection or management. NSSF 262 may be accessible via Nnssf interface 263. NSSF 262 may provide a list of allowed slices to AMF 220. AUSF 264 may perform authentication. For example, AUSF 264 may implement an Extensible Authentication Protocol (EAP) authentication server and may store authentication keys for UE devices 110 and/or WLAN access device 134. AUSF 264 may be accessible via Nausf interface 265.

NWDAF 268 may collect analytics information associated with radio access network 120 and/or core network 150. NWDAF 268 may collect KPI values for different locations for applications running on particular network slices and generate historical performance data based on the collected KPI values. NWDAF 268 may collect the KPI values from UE device 110 and/or WLAN access device 134, and/or from UPF 230 via SMF 240.

Although FIG. 2 shows exemplary components of core network 150, in other implementations, core network 150 may include fewer components, different components, differently arranged components, or additional components than depicted in FIG. 2. Additionally, or alternatively, one or more components of core network 150 may perform functions described as being performed by one or more other components of core network 150.

FIG. 3 is a diagram illustrating example components of a device 300 according to an implementation described herein. The components of FIG. 1 and/or FIG. 2 may each include one or more devices 300. As shown in FIG. 3, device 300 may include a bus 310, a processor 320, a memory 330, an input device 340, an output device 350, and a communication interface 360.

Bus 310 may include a path that permits communication among the components of device 300. Processor 320 may include any type of single-core processor, multi-core processor, microprocessor, latch-based processor, central processing unit (CPU), graphics processing unit (GPU), tensor processing unit (TPU), hardware accelerator, and/or processing logic (or families of processors, microprocessors, and/or processing logics) that interprets and executes instructions. In other embodiments, processor 320 may include an application-specific integrated circuit (ASIC), a field-programmable gate array (FPGA), and/or another type of integrated circuit or processing logic.

Memory 330 may include any type of dynamic storage device that may store information and/or instructions, for execution by processor 320, and/or any type of non-volatile storage device that may store information for use by processor 320. For example, memory 330 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 340 may allow an operator to input information into device 300. Input device 340 may include, for example, a keyboard, a mouse, a pen, a microphone, a remote control, an audio capture device, an image and/or video capture device, a touch-screen display, and/or another type of input device. In some implementations, device 300 may be managed remotely and may not include input device 340. In other words, device 300 may be “headless” and may not include a keyboard, for example.

Output device 350 may output information to an operator of device 300. Output device 350 may include a display, a printer, a speaker, and/or another type of output device. For example, device 300 may include a display, which may include a liquid-crystal display (LCD) for displaying content to the user. In some implementations, device 300 may be managed remotely and may not include output device 350. In other words, device 300 may be “headless” and may not include a display, for example.

Communication interface 360 may include a transceiver that enables device 300 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 360 may include a transmitter that converts baseband signals to RF signals and/or a receiver that converts RF signals to baseband signals. Communication interface 360 may be coupled to an antenna for transmitting and receiving RF signals.

Communication interface 360 may include a logical component that includes input and/or output ports, input and/or output systems, and/or other input and output components that facilitate the transmission of data to other devices. For example, communication interface 360 may include a network interface card (e.g., Ethernet card) for wired communications and/or a wireless network interface (e.g., a WiFi) card for wireless communications. Communication interface 360 may also include a universal serial bus (USB) port for communications over a cable, a Gigabit home networking (G.hn) interface for wired communication using coaxial cables, telephone wiring, power lines, and/or plastic optical fiber, a Bluetooth™ wireless interface, a radio-frequency identification (RFID) interface, a near-field communications (NFC) wireless interface, and/or any other type of interface that converts data from one form to another form.

As will be described in detail below, device 300 may perform certain operations relating to WLAN and cellular wireless core network interworking. Device 300 may perform these operations in response to processor 320 executing software instructions contained in a computer-readable medium, such as memory 330. A computer-readable medium may be defined as a non-transitory memory device. A memory device may be implemented within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of, or in combination with, software instructions to implement processes described herein. Thus, implementations described herein are not limited to any specific combination of hardware circuitry and software.

Although FIG. 3 shows exemplary components of device 300, in other implementations, device 300 may include fewer components, different components, additional components, or differently arranged components than depicted in FIG. 3. Additionally, or alternatively, one or more components of device 300 may perform one or more tasks described as being performed by one or more other components of device 300.

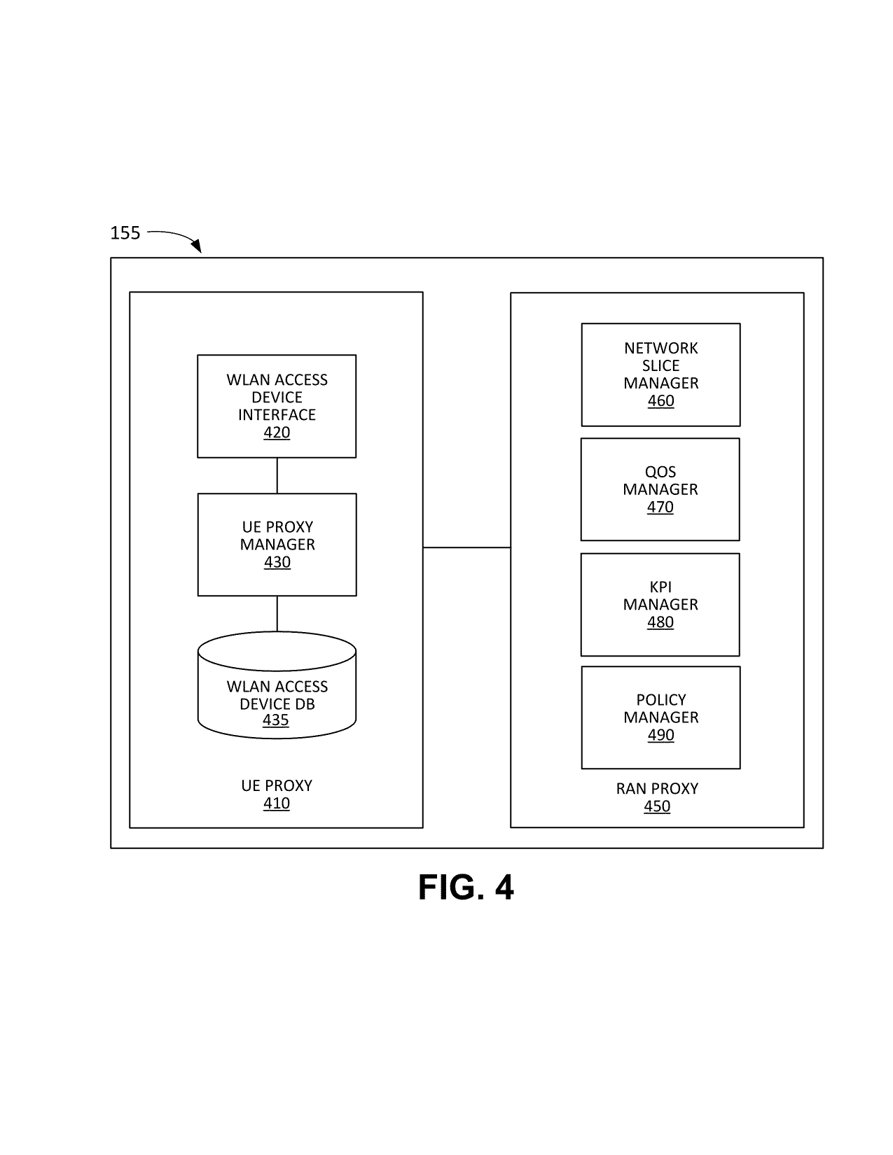

FIG. 4 illustrates exemplary components of UE and RAN proxy 155. The components of UE and RAN proxy 155 may be implemented, for example, via processor 320 executing instructions from memory 330. For example, one or more components of UE and RAN proxy 155 may correspond to the structure of processor 320 together with instructions in memory 330 for implementing the functionality of the component. Alternatively, some or all of the components of UE and RAN proxy 155 may be implemented via hard-wired circuitry. For example, one or more components of UE and RAN proxy 155 may correspond to the structure of some or all of an ASIC, FPGA, and/or another type of integrated circuit. As shown in FIG. 4, UE and RAN proxy 155 may include a UE proxy 410 and a RAN proxy 450.

UE proxy 410 may be configured to function as UE device 110 with respect to core network 150 on behalf of WLAN access device 134. UE proxy 410 may include a WLAN access device interface 420, a UE proxy manager 430, and a WLAN access device DB 435.

WLAN access device interface 420 may be configured to communicate with WLAN access device 134 using a data link layer PPP protocol. For example, WLAN access device interface 420 may receive a PPPoE request from WLAN access device 134 to establish a PDU session with core network 150. The PPPoE request may include a UE device ID associated with WLAN access device 134, such as, for example, an International Mobile Subscriber Identity (IMSI) associated with a UE device subscription for WLAN access device 134. Additionally, WLAN access device interface 420 may, after a PDU session is established, send downlink data traffic for the PDU session to WLAN access device 134 using PPPoE and receive uplink data traffic for the PDU session from WLAN access device 134 using PPPoE. In other implementations, WLAN access device interface 420 may be configured to communicate with WLAN access device 134 using a different protocol, such as, for example, an authentication protocol based on the IEEE 802.1X standards.

UE proxy manager 430 may function as a UE proxy on behalf of WLAN access device 134 with respect to core network 150. For example, UE proxy manager 430 may register, via RAN proxy 450, with core network 150 as a UE device with a UE device ID (e.g., IMSI, etc.) associated with WLAN access device 134 by sending a registration request to AMF 220 over N2 interface 212 and may receive a registration acceptance response from AMF 220 over N2 interface 212. UE proxy manager 430 may perform wireless security, encryption, and/or key management on behalf of WLAN access device 134 as required by the registration process with core network 150. UE proxy manager 430 may further establish a PDU session to UPF 230, and/or to MEC device 145 for any requested MEC services, over N3 interface 214 via RAN proxy 450. UE proxy manager 430 may then create one or more data flows in the established PDU session based on data flows requested by WLAN access device 134 for client devices 132.

UE proxy manager 430 may then proxy data traffic in the created data flows between WLAN access device 134 and UPF 230 via RAN proxy 450, and/or between WLAN access device 134 and MEC device 145 via RAN proxy 450. For example, UE proxy manager 430 may forward uplink data traffic for the PDU session received from WLAN access device 134 via PPPoE to UPF 230 and/or MEC device 145 using N3 interface 214 via RAN proxy 450. Furthermore, UE proxy manager 430 may receive downlink data traffic for the PDU session from UPF 230 and/or MEC device 145 via RAN proxy 450 using N3 interface 214 and forward the received downlink data traffic to WLAN access device 134 via PPPoE.

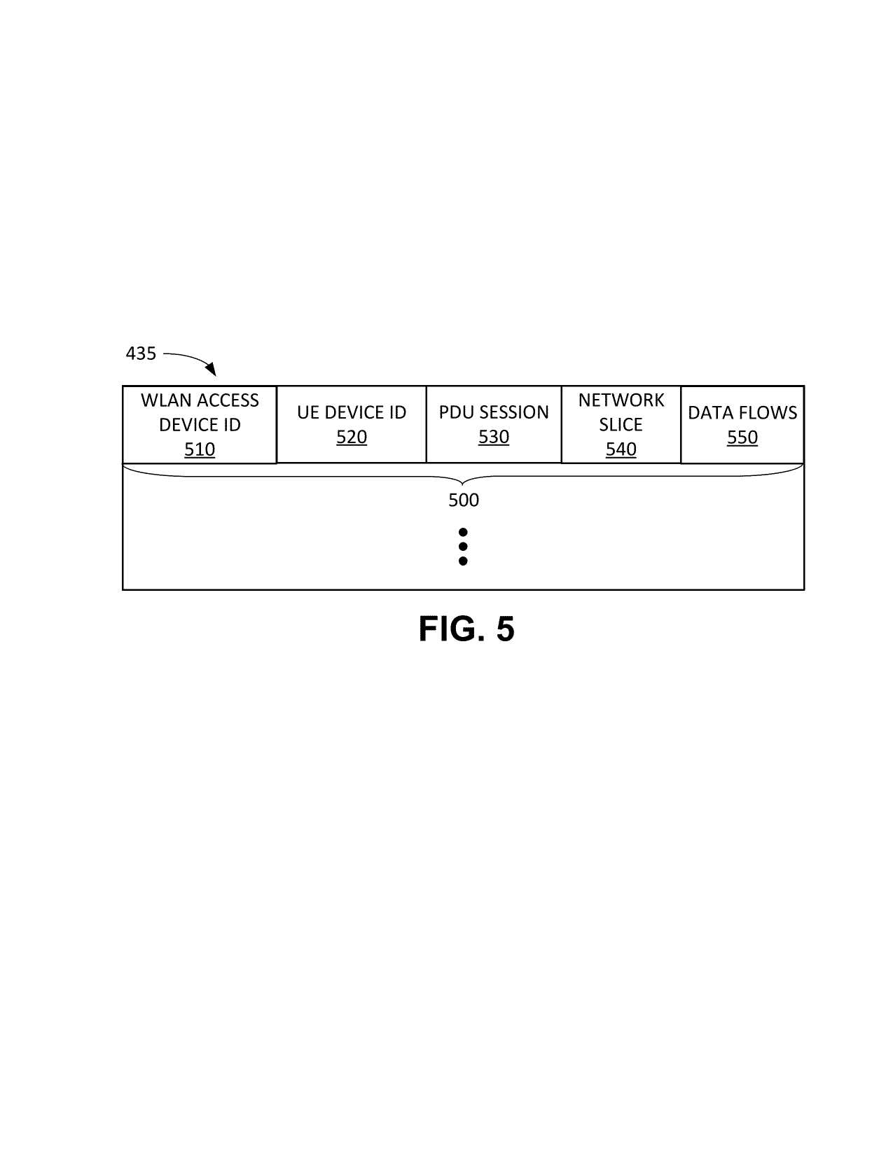

WLAN access device DB 435 may store information relating to particular WLAN access devices 134. Exemplary information that may be stored in WLAN access device DB 435 is described below with reference to FIG. 5.

RAN proxy 450 may be configured to function as gNodeB 210 with respect to core network 150 on behalf of WLAN access device 134. Furthermore, RAN proxy 450 may be configured to function as a proxy for other components of RAN 120 that may be configured to implement a service requirement for a communication session, such as, for example, a transport network component (e.g., a programmable switch) in RAN 120. For example, RAN proxy 450 may implement N2 interface 212 to communicate with AMF 220 and/or N3 interface 214 to communicate with UPF 230 and/or MEC device 145. Furthermore, RAN proxy 450 may establish a GTP tunnel to UPF 230 and an IPSec tunnel to WLAN access device 134.

Additionally, RAN proxy 450 may apply one or more RAN policies for a PDU session and/or data flows in a PDU session. For example, RAN proxy 450 may receive one or more RAN policies from PCF 254 via AMF 220. The RAN policies may include network slice policies, QoS policies, KPI reporting policies, and/or other types of policies. RAN proxy 450 may include a network slice manager 460, a QoS manager 470, a KPI manager 480, and a policy manager 490.

Network slice manager 460 may enforce network slice policy requirements for a RAN associated with a network slice. For example, network slice manager 460 receive an indication that a PDU session has been assigned to a network slice, determine one or more policies and/or requirements associated with the network slice, and apply the determined policies and/or requirements to data units associated with the PDU session. The network slice policies and/or requirements may include a latency requirement, a throughput requirement, a data unit time delay variation (e.g., jitter) requirement, a data unit delivery reliability requirement, a security requirement, and/or another type of requirement.

QoS manager 470 may enforce QoS requirements for a RAN associated with a network slice. For example, QoS manager 470 receive an indication that a data flow has been assigned to a 5QI and apply the determined 5QI to data units associated with the data flow.

KPI manager 480 may apply a policy to collect values for one or more KPIs and send collected KPI values to NWDAF 268 and/or another analytics device. For example, KPI manager 480 may collect and report latency KPI values, throughput KPI values, jitter KPI values, etc. Policy manager 490 may apply other types of policies to a PDU session and/or data flows associated with WLAN access device 134, such as, for example, a security policy that blacklists certain types of client devices 132 from accessing core network 150, a policy that routes certain application sessions to MEC device 145, a spending limit policy that limits the throughput for a particular subscription, subscription type, application, and/or application type, and/or other types of policies that may be applied by core network 150 to WLAN access device 134.

Although FIG. 4 shows exemplary components of UE and RAN proxy 155, in other implementations, UE and RAN proxy 155 may include fewer components, different components, additional components, or differently arranged components than depicted in FIG. 4. Additionally, or alternatively, one or more components of UE and RAN proxy 155 may perform one or more tasks described as being performed by one or more other components of UE and RAN proxy 155.

FIG. 5 illustrates exemplary components of WLAN access device DB 435. As shown in FIG. 5, WLAN access device DB 435 may include one or more WLAN access device records 500. Each WLAN access device record 500 may include information relating to a particular WLAN access device 134. WLAN access device record 500 may include a WLAN access device ID field 510, a UE device ID field 520, a PDU session field 530, a network slice field 540, and a data flows field 550.

WLAN access device ID field 510 may store an ID associated with WLAN access device 134. For example, WLAN access device ID field 510 may store a WI-FI router ID and/or credentials that enable WLAN access device 134 to register with UE and RAN proxy 155 and to enable UE and RAN proxy 155 to authenticate WLAN access device 134.

UE device ID field 520 may store a UE device ID associated with WLAN access device 134 and used to identify a subscription for WLAN access device 134 in UDM 252. For example, UE device ID field 520 may store a Mobile Directory Number (MDN), an IMSI, a Mobile Station International Subscriber Directory Number (MSISDN), an International Mobile Equipment Identity (IMEI), and/or another type of UE device and/or subscription ID. Furthermore, UE device ID field 520 may store authentication credentials and/or keys required to authenticate and/or register WLAN access device 134 as a UE device with core network 150.

PDU session field 530 may store information identifying a PDU session associated with WLAN access device 134. Network slice field 540 may store information identifying a network slice associated with the PDU session. Data flows field 550 may store information identifying one or more data flows associated with the PDU session. For example, for each data flow, data flows field 550 may store a data flow ID, a 5QI associated with the data flow, one or more policies associated with the data flow, one or more KPI values associated with the data flow, and/or other types of information associated with the data flow.

Although FIG. 5 shows exemplary components of WLAN access device DB 435, in other implementations, WLAN access device DB 435 may include fewer components, different components, additional components, or differently arranged components than depicted in FIG. 5.

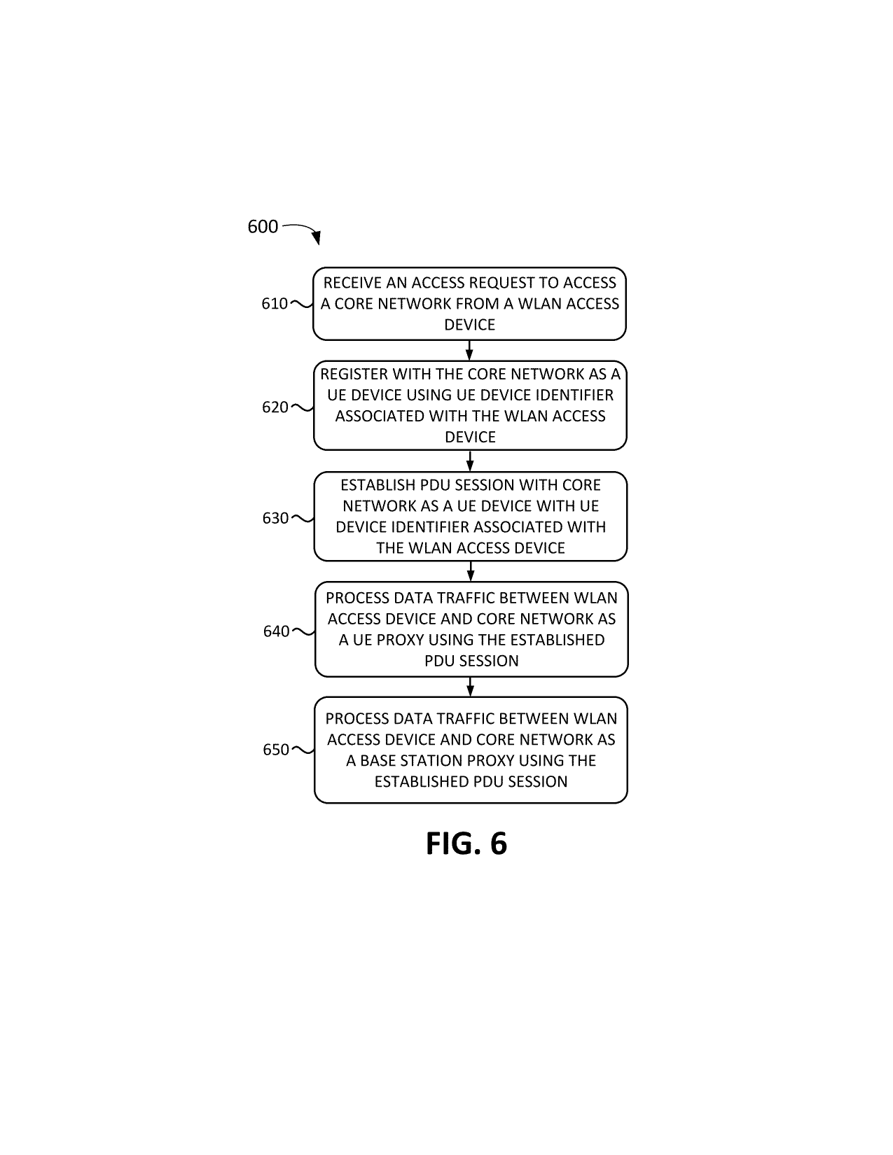

FIG. 6 illustrates a flowchart of a process 600 for interworking between a WLAN and core network 150. In some implementations, process 600 of FIG. 6 may be performed by UE and RAN proxy 155. In other implementations, some or all of process 600 may be performed by another device or a group of devices separate from UE and RAN proxy 155.

As shown in FIG. 6, process 600 may include receiving an access request to access a core network from a WLAN access device (block 610). For example, UE and RAN proxy 155 may receive a PPPoE request from WLAN access device 134 to establish a PDU session with core network 150. The PPPoE request may include a UE device ID associated with WLAN access device 134, such as, for example, an IMSI associated with a UE device subscription for WLAN access device 134. In other implementations, UE and RAN proxy 155 may be configured to authenticate WLAN access device 134 using a different protocol, such as, for example, an authentication protocol based on the IEEE 802.1X standards.

Process 600 may further include registering with the core network as a UE device using a UE device ID associated with the WLAN access device (block 620) and establishing a PDU session with the core network as a UE device with the UE device ID associated with the WLAN access device (block 630). For example, UE and RAN proxy 155 may register with core network 150 as a UE device with a UE device ID (e.g., IMSI, etc.) associated with WLAN access device 134 by sending a registration request to AMF 220 over N2 interface 212 and may receive a registration acceptance response from AMF 220 over N2 interface 212. UE and RAN proxy 155 may further establish a PDU session to UPF 230, and/or to MEC device 145 for any requested MEC services, over N3 interface 214 via RAN proxy 450. UE and RAN proxy 155 may then create one or more data flows in the established PDU session based on data flows requested by WLAN access device 134 for client devices 132. UE and RAN proxy 155 may perform wireless security, encryption, and/or key management on behalf of WLAN access device 134 during the registration process with core network 150.

Process 600 may further include processing data traffic between the WLAN access device and the core network as a UE device proxy using the established PDU session (block 640) and processing data traffic between the WLAN access device and the core network as a base station proxy using the established PDU session (block 650). For example, UE and RAN proxy 155 may proxy data traffic in the created data flows between WLAN access device 134 and UPF 230 via RAN proxy 450, and/or between WLAN access device 134 and MEC device 145 via RAN proxy 450. UE and RAN proxy 155 may establish a GTP tunnel to UPF 230 and an IPSec tunnel to WLAN access device 134. UE and RAN proxy 155 may forward uplink data traffic for the PDU session received from WLAN access device 134 via PPPoE to UPF 230 and/or MEC device 145 using N3 interface 214 via RAN proxy 450. Furthermore, UE and RAN proxy 155 may receive downlink data traffic for the PDU session from UPF 230 and/or MEC device 145 via RAN proxy 450 using N3 interface 214 and forward the received downlink data traffic to WLAN access device 134 via PPPoE.

Additionally, UE and RAN proxy 155 may apply one or more RAN policies for the PDU session and/or data flows in the PDU session. The RAN policies may include a network slice policy that applies a requirement associated with a network slice to a PDU session, such as, for example, a latency requirement, a throughput requirement, a data unit time delay variation (e.g., jitter) requirement, a data unit delivery reliability requirement, a security requirement, and/or another type of requirement. The RAN policies may include a QoS requirement associated with a data flow in the PDU session. The RAN policies may include a policy to collect and report values associated with a KPI, such as, for example, latency KPI values, throughput KPI values, jitter KPI values, etc. The RAN policies may include other types of policies, such as, for example, a security policy that blacklists certain types of client devices 132 from accessing core network 150, a policy that routes certain application sessions to MEC device 145, a spending limit policy that limits the throughput for a particular subscription, subscription type, application, and/or application type, and/or other types of policies that may be applied by core network 150 to WLAN access device 134.

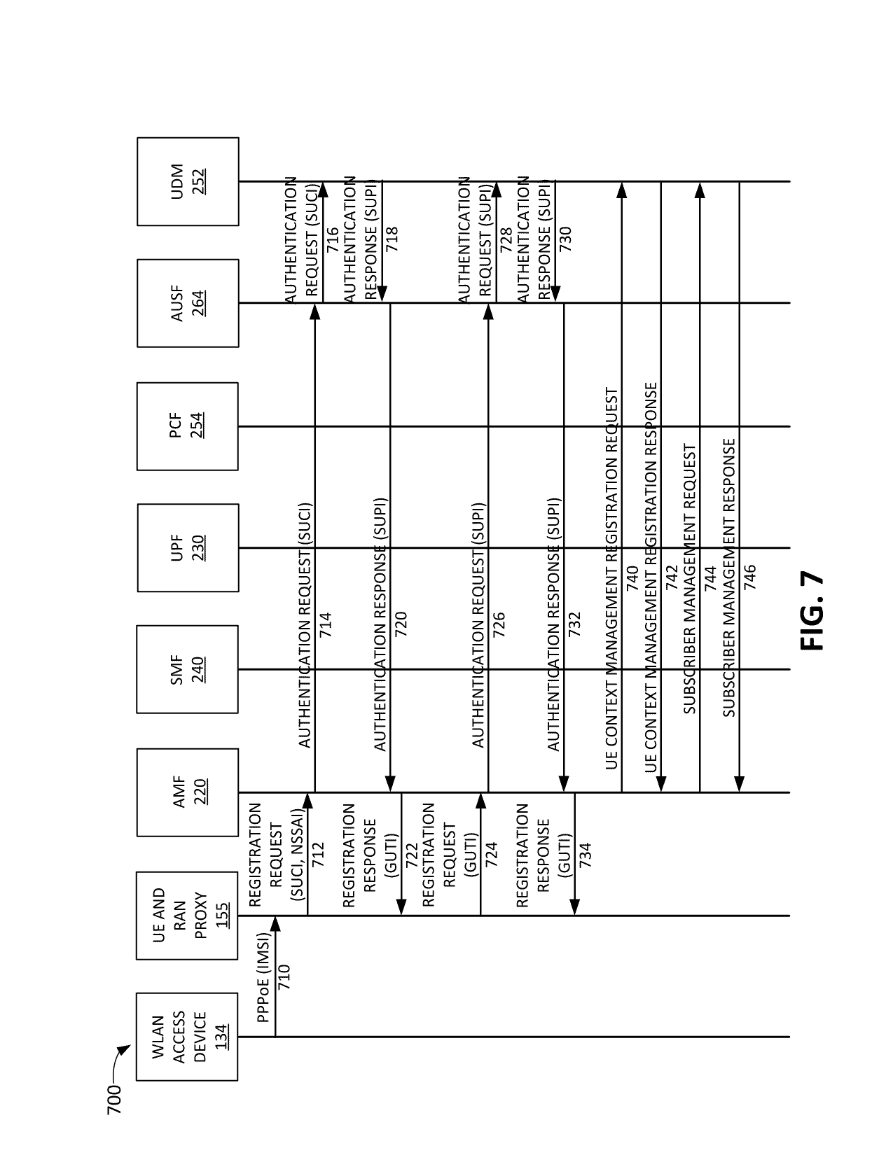

FIG. 7 illustrates a first exemplary signal flow diagram 700. Signal flow 700 illustrates interworking between a WLAN and core network 150. As shown in FIG. 7, signal flow 700 may include WLAN access device 134 sending a PPPoE message to UE and RAN proxy 155 (signal 710). The PPPoE message may include a request to establish a PDU session in core network 150 to application server 165 using the IMSI associated with WLAN access device 134. WLAN access device 134 may send the request to establish the PDU session based on a Dynamic Host Configuration Protocol (DHCP) Discovery message from client device 132 seeking to establish an IP connection to application server 165 (not shown in FIG. 7).

In response to receiving the PPPoE message, UE and RAN proxy 155 may send a registration request to AMF 220 (signal 712). The registration request may include a Subscription Concealed Identifier (SUCI) generated by UE and RAN proxy 155 based on the IMSI. The registration request may further include an NSSAI requesting a particular network slice. In some implementations, UE and RAN proxy 155 may select a default network slice assigned to WLAN access device 134. In other implementations, UE and RAN proxy 155 may select a network slice based on an application ID included in the request received from WLAN access device 134, based on a device type associated with client device 132 requesting the connection, and/or based on another criterion.

In response to receiving the registration request, AMF 220 may send an authentication request to AUSF 264 with the SUCI (signal 714) and AUSF 264 may send an authentication request to UDM 252 with the SUCI (signal 716). UDM 252 may authenticate WLAN access device 155 based on the SUCI and the subscription record for WLAN access device 155 maintained by UDM 252 in a UDR and respond with an authentication response that includes a Subscriber Permanent ID (SUPI) associated with WLAN access device 155 (signal 718). AUSF 264 may forward the authentication response with the SUPI to AMF 220 (signal 720). AMF 220 may send a registration response to UE and RAN proxy 155 with a Global Unique Temporary ID (GUTI) (signal 722). UE and RAN proxy 155 may then repeat the registration request with the SUPI and receive a registration response with the GUTI to complete authentication (signals 724, 726, 728, 730, 732, and 734). AMF 220 may then send a UE context management registration request to UDM 252 (signal 740) and UDM 252 may respond with a UE context management registration response (signal 742). AMF 220 may then send a subscriber management request to UDM 252 (signal 744) and UDM 252 may respond with a subscriber management response (signal 746).

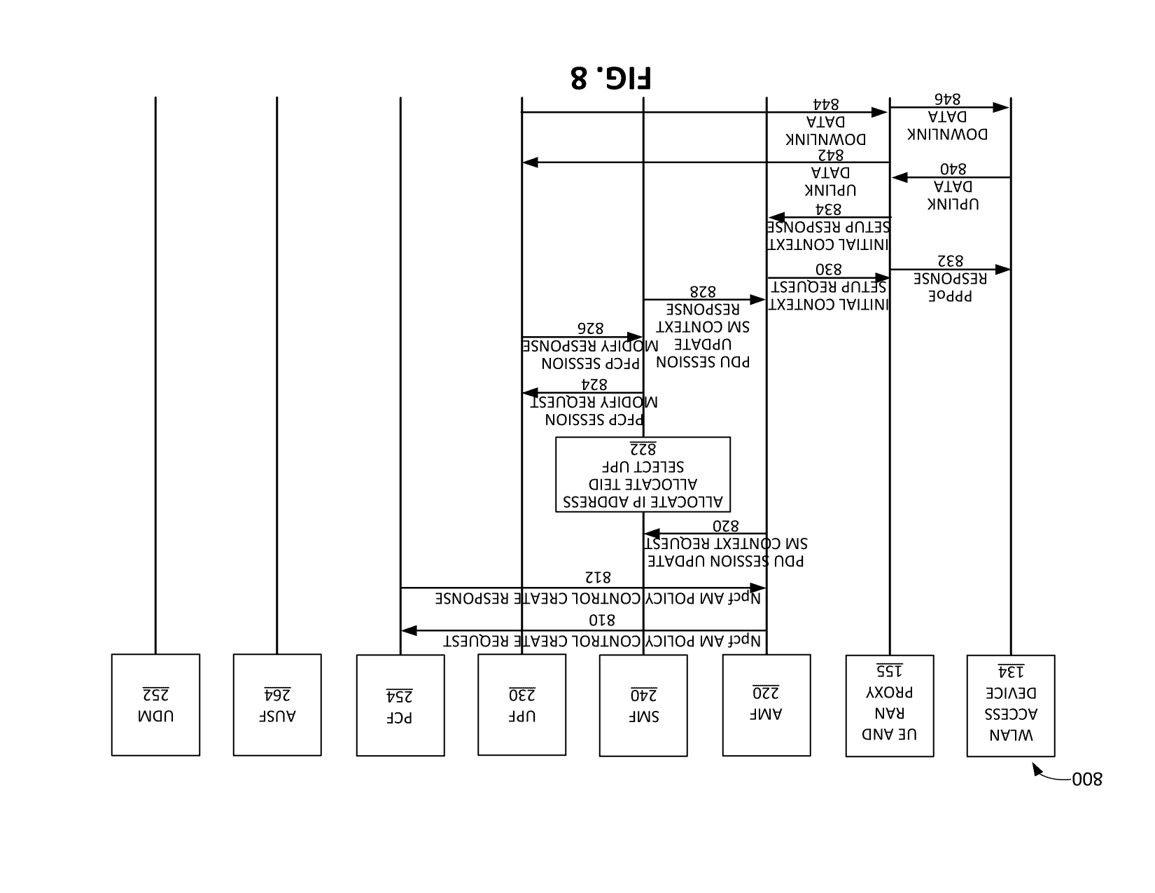

FIG. 8 illustrates a second exemplary signal flow diagram 800. Signal flow 800 illustrates the continuation of signal flow 700. As shown in FIG. 8, signal flow 800 may include AMF 220 sending a policy control create request to PCF 254 via Npcf interface 255 using the SUPI (signal 810) and PCF 254 may respond with the policies for the PDU session being established by sending a policy control create response to AMF 220 (signal 812). The policy control create response may include a policy association request for the SUPI.

AMF 220 may then send a PDU session update Session Management (SM) context request to SMF 240 (signal 820) with the policies provided by PCF 254. SMF 240 may allocate an IP address to UE and RAN proxy 155 in core network 150, allocate a Tunnel Endpoint ID (TEID) for a GTP tunnel to UPF 230, and select UPF 230 (block 822).

SMF 240 may then send a Packet Forwarding Control Protocol (PFCP) session modify request to UPF 230 using the TEID (signal 824) and UPF 230 may respond with a PCP session modify response using the TEID (signal 826). SMF 240 may then send a PDU session update SM context response to AMF 220 using the TEID (signal 828). The PDU session update SM context response may include information identifying UPF 230 and the allocated IP address.

AMF 220 may send an initial context setup request to UE and RAN proxy 155 (signal 830). The initial context setup request may include the TEID, information identifying UPF 230, and the allocated IP address. UE and RAN proxy 155 may respond with an initial context setup response with the TEID (signal 834). The PDU session establishment may thus be completed. WLAN access device 134 may then send uplink data to UPF 230 via UE and RAN proxy 155 using the established PDU session (signals 840 and 842). WLAN access device 13 may also receive downlink data from UPF 230 via UE and RAN proxy 155 using the established PDU session (signals 844 and 846).

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIG. 6, and a series of signals have been described with respect to FIGS. 7 and 8, the order of the blocks, and/or signals, may be modified in other implementations. Further, non-dependent blocks and/or signals may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code--it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises” / “comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store, or employ personal information of individuals, it should be understood that such information shall be collected, stored, and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article "a" is intended to include one or more items. Further, the phrase "based on" is intended to mean "based, at least in part, on" unless explicitly stated otherwise.

What is claimed is:

1. A method comprising:
receiving, by a device, an access request to access a core network from a Wireless Local Area Network (WLAN) access device;
registering, by the device, with the core network as a User Equipment (UE) device using a UE device identifier associated with the WLAN access device, based on receiving the request to access the core network from the WLAN access device;
establishing, by the device, a Protocol Data Unit (PDU) session with the core network as a UE device using the UE device identifier associated with the WLAN access device; and
proxying, by the device, data traffic between the WLAN access device and core network using the established PDU session.

2. The method of claim 1, wherein registering with the core network as a UE device includes:
sending a registration request, using the UE device identifier associated with the WLAN access device, to an Access and Mobility Management Function (AMF) associated with the core network; and
receiving a registration acceptance from the AMF based on the sent registration request.

3. The method of claim 1, wherein registering with the core network as a UE device includes:
sending a registration request to the core network using an N2 interface.

4. The method of claim 1, wherein proxying data traffic between the WLAN access device and core network using the established PDU session includes:
identifying a User Plane Function (UPF) associated with the PDU session;
sending uplink data traffic for the PDU session from the WLAN access device to the identified UPF; and
receiving downlink data traffic for the PDU session from the identified UPF.

5. The method of claim 1, wherein proxying data traffic between the WLAN access device and core network using the established PDU session includes:
sending uplink data traffic for the PDU session to the core network using an N3 interface; and
receiving downlink data traffic for the PDU session from the core network using the N3 interface.

6. The method of claim 1, wherein proxying data traffic between the WLAN access device and core network using the established PDU session includes:
authenticating the WLAN access device using at least one of Point-to-Point Protocol over Ethernet (PPPoE) or an 802.1X authentication protocol.

7. The method of claim 1, wherein proxying data traffic between the WLAN access device and core network using the established PDU session includes:
processing the data traffic as a gNodeB proxy.

8. The method of claim 7, wherein processing the data traffic as the gNodeB proxy includes:
receiving an indication that the PDU session has been assigned to a network slice; and
processing data traffic associated with the PDU session based on one or more requirements associated with the network slice.

9. The method of claim 7, wherein processing the data traffic as the gNodeB proxy includes:
determining a Fifth Generation Quality of Service Identifier (5QI) associated with a data flow in the established PDU session; and
processing data units associated with the data flow based on the determined 5QI.

10. The method of claim 7, wherein processing the data traffic as the gNodeB proxy includes:
reporting at least one Key Performance Indicator (KPI) value to a Network Data Analytics Function (NWDAF) associated with the core network.

11. The method of claim 7, wherein processing the data traffic as the gNodeB proxy includes:
establishing, for the PDU session, a General Packet Radio Service Tunnelling Protocol (GTP) tunnel between the device and a User Plane Function (UPF) associated with the PDU session; and
establishing, for the PDU session, an Internet Protocol Security (IPSec) tunnel between the device and the WLAN access device.

12. A device comprising:
a processor configured to:
receive an access request to access a core network from a Wireless Local Area Network (WLAN) access device;
register with the core network as a User Equipment (UE) device using a UE device identifier associated with the WLAN access device, based on receiving the request to access the core network from the WLAN access device;
establish a Protocol Data Unit (PDU) session with the core network as a UE device using the UE device identifier associated with the WLAN access device; and
proxy data traffic between the WLAN access device and core network using the established PDU session.

13. The device of claim 12, wherein, when registering with the core network as a UE device, the processor is further configured to:
send a registration request to an Access and Mobility Management Function (AMF) associated with the core network using an N2 interface, wherein the registration request includes the UE device identifier associated with the WLAN access device; and
receive a registration acceptance from the AMF based on the sent registration request.

14. The device of claim 12, wherein, when proxying data traffic between the WLAN access device and core network using the established PDU session, the processor is further configured to:
identify a User Plane Function (UPF) associated with the PDU session;
send uplink data traffic for the PDU session from the WLAN access device to the identified UPF using an N3 interface; and
receive downlink data traffic for the PDU session from the identified UPF using the N3 interface.

15. The device of claim 12, wherein, when proxying data traffic between the WLAN access device and core network using the established PDU session, the processor is further configured to:
authenticate the WLAN access device using at least one of Point-to-Point Protocol over Ethernet (PPPoE) or an 802.1X authentication protocol.

16. The device of claim 12, wherein, when proxying data traffic between the WLAN access device and core network using the established PDU session, the processor is further configured to:
process the data traffic as a gNodeB proxy.

17. The device of claim 16, wherein, when processing the data traffic as the gNodeB proxy, the processor is further configured to:
receive an indication that the PDU session has been assigned to a network slice; and
process data traffic associated with the PDU session based on one or more requirements associated with the network slice.

18. The device of claim 16, wherein, when processing the data traffic as the gNodeB proxy, the processor is further configured to:
determine a Fifth Generation Quality of Service Identifier (5QI) associated with a data flow in the established PDU session; and
process data units associated with the data flow based on the determined 5QI.

19. The device of claim 16, wherein, when processing the data traffic as the gNodeB proxy, the processor is further configured to:
establish, for the PDU session, a General Packet Radio Service Tunnelling Protocol (GTP) tunnel between the device and a User Plane Function (UPF) associated with the PDU session; and
establish, for the PDU session, an Internet Protocol Security (IPSec) tunnel between the device and the WLAN access device.

20. A non-transitory computer-readable memory device storing instructions executable by a processor, the non-transitory computer-readable memory device comprising:
one or more instructions to receive an access request to access a core network from a Wireless Local Area Network (WLAN) access device;
one or more instructions to register with the core network as a User Equipment (UE) device using a UE device identifier associated with the WLAN access device, based on receiving the request to access the core network from the WLAN access device;
one or more instructions to establish a Protocol Data Unit (PDU) session with the core network as a UE device using the UE device identifier associated with the WLAN access device; and
one or more instructions to proxy data traffic between the WLAN access device and core network using the established PDU session.
